(19) United States
(12) Patent Application Publication
(10) Pub. No.: US 2002/0028879 A1
(43) Pub. Date: Mar. 7, 2002

(54) Powder coating compositions containing carbamate functional polymers

(76) Inventors: Anthony M. Chasser, Allison Park, PA (US); Paul H. Lamers, Allison Park, PA (US); John R. Schneider, Glenshaw, PA (US); Ronald R. Ambrose, Allison Park, PA (US)

Correspondence Address: PPG Industries, Inc., One PPG Place, Pittsburgh, PA, 15272, US

(21) Appl. No.: 09/946,371

(22) Filed: Sep. 4, 2001

Related U.S. Application Data
(62) Division of application No. 09/538,836, filed on Mar. 30, 2000.
Application No. 09/538,836 is a continuation-in-part of application No. 09/500,672, filed on Feb. 9, 2000.
Application No. 09/500,672 is a division of application No. 08/995,790, filed on Dec. 22, 1997, now Pat. No. 6,046,276.
Application No. 08/995,790 is a continuation-in-part of application No. 08/904,597, filed on Aug. 1, 1997, now Pat. No. 5,939,491.

(51) Int. Cl. C08J 3/24

(52) U.S. Cl. 525/101; 525/100; 525/107; 528/26; 528/27

(57) ABSTRACT

A powder coating composition of a solid particulate film-forming mixture including (a) a carbamate group-containing polymer having a glass transition temperature of at least 30° C.; and (b) a curing agent having functional groups reactive with the carbamate functional groups of the polymer. Also provided is a multi-component composite coating composition characterized by a pigmented basecoat deposited from a pigmented film-forming composition and a substantially pigment-free top coat applied over the basecoat. The top coat is deposited from the powder coating composition. A method of forming a wrinkled coating on a substrate is further provided where a curable powder coating composition is prepared from a solid particulate film-forming mixture, applied to a substrate and thermally cured to form a continuous coating having a wrinkled surface. The solid particulate film-forming mixture includes (a) a carbamate functional group-containing polymer having a glass transition temperature at least 30° C., (b) a curing agent having functional groups reactive with the carbamate functional groups of the polymer (a), and (c) an amine salt of an acid catalyst. Coated substrates are also provided.

This is a Continuation-in-Part Application of U.S. patent application Ser. No. 09/500,672, filed Feb. 9, 2000, which is a Divisional Application of U.S. patent application Ser. No. 08/995,790, filed Dec. 22, 1997, which is a Continuation-in-Part Application of patent application Ser. No. 08/904,597, filed on Aug. 1, 1997, now U.S. Pat. No. 5,939,491, issued Aug. 17, 1999

### FIELD OF THE INVENTION

The present invention relates to powder coating compositions containing carbamate functional polymers and carbamate reactive curing agents.

### BACKGROUND OF THE INVENTION

In recent years, powder coatings have become increasingly popular because these coatings are inherently low in volatile organic content (“VOC”), which significantly reduces emissions of volatile organic compounds into the atmosphere during the application and curing processes. Hydroxyl and/or epoxy functional condensation polymers, vinyl chloride polymers and hydroxyl and/or epoxy functional acrylic resins are commonly used as main film-forming polymers for these coatings.

Acrylic resin systems are particularly advantageous for use in powder coating compositions because they provide coatings having superior outdoor durability and improved solvent and chemical resistance. Moreover, because acrylic polymer systems can be more heat-resistant than condensation polymers, they can provide powder coating compositions having improved storage stability. However, when exposed to the extreme temperatures which can be encountered during shipping and/or storage in many geographic areas, even better powder stability is desired.

Also, many geographic areas encounter acidic and/or hard water precipitation, therefore, resistance to etching by atmospheric acid precipitation (“acid etch resistance”) is becoming increasingly desirable properties for coatings. Original equipment manufacturers are requiring that coating systems demonstrate such acid etch resistance. Powder coating compositions based on epoxy functional polymers, such as those discussed above, and polyacid curing agents have very good acid etch resistance. However, these powder coating systems can exhibit poor mar and abrasion resistance. It would be desirable to provide a powder coating composition having not only excellent acid etch resistance, but also good mar and abrasion resistance.

Carbamate functional polymers are well known in the art as suitable film-forming resins for liquid coating systems where, for example, when combined with an aminoplast curing agent, they provide coatings having excellent acid etch resistance. These carbamate functional polymers further provide coatings which have excellent durability and adhesion properties To date, however, little use has been made of carbamate functional polymers in powder coating compositions.

Known in the art is the reaction of hydroxyl group-containing polymers with silanes. U.S. Pat. No. 4,877,837 to Reising, et al. discloses the condensation reaction between polymers containing —C—OH groups and the HO—Si— groups of an organosiloxane to form a —C—O—Si— linkage. However, there appears to be no reference in the powder coating art to a crosslinking reaction via the condensation reaction between polymers containing carbamate functional groups, that is —CONH₂ groups, and HO—Si— groups of an organosiloxane to form a —CONH—O—Si— linkage.

It has now been found that the inclusion of carbamate functionality in polymers suitable for use in powder coatings substantially increases the glass transition temperature (T_{g}) of the polymer without a significant increase in molecular weight. Such carbamate functional group-containing polymers having an increased T_{g} provide powder coating compositions having excellent storage stability even at increased temperatures. Moreover, the desirable coating properties which are usually associated with liquid coating compositions containing carbamate functional polymers, i.e., superior acid etch resistance, durability and adhesion, are likewise present for coatings derived from analogous powder coating compositions. Further, it has been found that the use of an organosiloxane having HO—Si— groups as a curing agent for carbamate functional group-containing polymers provides powder coatings having improved heat resistance, chemical resistance and powder stability.

### SUMMARY OF THE INVENTION

In accordance with the present invention, provided is a powder coating composition comprising a solid particulate film-forming mixture of (a) a polymer comprising pendent and/or terminal carbamate functional groups, said polymer having a T_{g} of at least 30° C.; and (b) a curing agent having functional groups reactive with the carbamate functional groups of the polymer (a). Also provided is a multi-component composite coating composition comprising a pigmented basecoat deposited from a pigmented film-forming composition and a substantially pigment-free top coat applied over the basecoat, which is deposited from the powder coating composition.

Further provided is a method of forming a wrinkled coating on a substrate by (1) preparing a curable powder coating composition by forming a solid particulate film-forming mixture of (a) a polymer comprising pendent and/or terminal carbamate functional groups, the polymer having a T_{g} of at least 30° C.; (b) a curing agent having functional groups reactive with the carbamate functional groups of the polymer (a); and (c) a catalyst comprising an amine salt of an acid; (2) applying the powder coating composition to a substrate; and (3) thermally curing the powder coated substrate to form thereon a continuous, wrinkled film. Coated substrates are also provided.

Other than in the operating examples, or where otherwise indicated, all numbers expressing quantities of ingredients, reaction conditions and so forth used in the specification and claims are to be understood as being modified in all instances by the term “about.” Also, as used herein, the term “polymer” is meant to refer to oligomers and both homopolymers and copolymers. Unless stated otherwise, as used in the specification and the claims, molecular weights are number average molecular weights for polymeric materials indicated as “Mn” and obtained by gel permeation chromatography using a polystyrene standard in an art-recognized manner.

### DETAILED DESCRIPTIVE OF THE INVENTION

The powder coating compositions of the present invention comprise a solid particulate film-forming mixture of (a) a polymer comprising pendent and/or terminal carbamate functional groups, that is, functional groups of the structure (I):

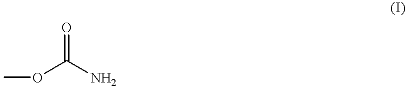

the polymer having a T_{g} of at least 30° C.; and (b) a curing agent having functional groups reactive with the carbamate functional groups of the polymer (a).

The polymer (a) can be any of the polymers having pendent and/or terminal carbamate functional groups which are well known in the art, so long as the T_{g} of the polymer is sufficiently high to permit the formation of a stable, solid particulate composition. The T_{g} of the polymer (a) typically is at least 30° C., preferably at least 40° C., more preferably at least 60° C., and even more preferably at least 90° C. The T_{g} of the polymer (a) also is typically less than 200° C., preferably less than 150° C., more preferably less than 130° C., and even more preferably less than 110° C. The T_{g} of the carbamate functional group-containing polymer (a) can range between any combination of these values inclusive of the recited values.

The T_{g} of the polymer can be calculated as described by Fox in Bull. Amer. Physics. Soc., 1,3 page 123 (1956). The T_{g} can also be measured experimentally using differential scanning calorimetry (rate of heating 10° C. per minute, T_{g} taken at the first inflection point). Unless otherwise indicated, the stated T_{g} as used herein refers to the calculated T_{g}.

Non-limiting examples of polymers having pendent and/or terminal carbamate functional groups useful in the powder coating compositions of the invention as the polymer (a) include those selected from the group consisting of acrylic, polyester, polyurethane and polyether polymers. Carbamate functional group-containing acrylic polymers are preferred.

Suitable carbamate functional group-containing acrylic polymers include copolymers prepared from one or more alkyl esters of acrylic acid or methacrylic acid and, optionally, one or more other polymerizable ethylenically unsaturated monomers. Suitable alkyl esters of acrylic or methacrylic acid include methyl methacrylate, ethyl methacrylate, butyl methacrylate, ethyl acrylate, butyl acrylate and 2-ethylhexyl acrylate. Suitable other polymerizable ethylenically unsaturated monomers include vinyl aromatic compounds, such as styrene and vinyl toluene; nitrites, such as acrylonitrile and methacrylonitrile; vinyl and vinylidene halides, such as vinyl chloride and vinylidene fluoride and vinyl esters, such as vinyl acetate.

The preferred acrylic polymers contain hydroxyl functionality which can be incorporated into the acrylic polymer through the use of hydroxyl functional monomers such as hydroxyethyl acrylate, hydroxypropyl acrylate, hydroxyethyl methacrylate and hydroxypropyl methacrylate which may be copolymerized with the other acrylic monomers.

In a preferred embodiment of the invention, the acrylic polymer can be prepared from ethylenically unsaturated, beta-hydroxy ester functional monomers. Such monomers are derived from the reaction of an ethylenically unsaturated acid functional monomer, such as monocarboxylic acids, for example, acrylic acid, and an epoxy compound which does not participate in the free radical initiated polymerization with the unsaturated acid monomer. Examples of such epoxy compounds are glycidyl ethers and esters. Suitable glycidyl ethers include glycidyl ethers of alcohols and phenols, such as butyl glycidyl ether, octyl glycidyl ether, phenyl glycidyl ether and the like. Suitable glycidyl esters include those which are commercially available from Shell Chemical Company under the tradename CARDURA E; and from Exxon Chemical Company under the tradename GLYDEXX-10.

Alternatively, the beta-hydroxy ester functional monomers are prepared from an ethylenically unsaturated, epoxy functional monomer, for example glycidyl methacrylate and allyl glycidyl ether, and a saturated carboxylic acid, such as a saturated monocarboxylic acid, for example, isostearic acid.

The acrylic polymer is typically prepared by solution polymerization techniques in the presence of suitable initiators such as organic peroxides or azo compounds, for example, benzoyl peroxide or N,N-azobis(isobutyronitrile). The polymerization can be carried out in an organic solution in which the monomers are soluble by techniques conventional in the art.

Pendent and/or terminal carbamate functional groups can be incorporated into the acrylic polymer by copolymerizing the acrylic monomer with a carbamate functional vinyl monomer, such as a carbamate functional alkyl ester of methacrylic acid. These carbamate functional alkyl esters are prepared by reacting, for example, a hydroxyalkyl carbamate, such as the reaction product of ammonia and ethylene carbonate or propylene carbonate, with methacrylic anhydride. Other carbamate functional vinyl monomers can include the reaction product of hydroxyethyl methacrylate, isophorone diisocyanate and hydroxypropyl carbamate. Still other carbamate functional vinyl monomers may be used, such as the reaction product of isocyanic acid (HNCO) with a hydroxyl functional acrylic or methacrylic monomer such as hydroxyethyl acrylate, and those carbamate functional vinyl monomers described in U.S. Pat. No. 3,479,328.

As is preferred, carbamate groups can also be incorporated into the acrylic polymer by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether.

The low molecular weight carbamate functional material derived from an alcohol or glycol ether is first prepared by reacting the alcohol or glycol ether with urea in the presence of a catalyst such as butyl stannoic acid. Suitable alcohols include lower molecular weight aliphatic, cycloaliphatic and aromatic alcohols, such as methanol, ethanol, propanol, butanol, cyclohexanol, 2-ethylhexanol and 3-methylbutanol. Suitable glycol ethers include ethylene glycol methyl ether and propylene glycol methyl ether. Propylene glycol methyl ether is preferred.

Also, hydroxyl functional acrylic polymers can be reacted with isocyanic acid yielding pendent carbamate groups Note that the production of isocyanic acid is disclosed in U.S. Pat. No. 4,364,913. Likewise, hydroxyl functional acrylic polymers can be reacted with urea to give an acrylic polymer with pendent carbamate groups.

The carbamate functional group-containing acrylic polymer typically has an Mn ranging from 500 to 30,000 and preferably from 1000 to 5000, with a calculated carbamate equivalent weight typically within the range of 15 to 150, and preferably less than 50, based on equivalents of reactive carbamate groups.

Non-limiting examples of carbamate functional polyester polymers suitable for use as the polymer (a) in the powder coating compositions of the present invention include linear or branched polyesters having carbamate functionality. Such polyester polymers are generally prepared by the polyesterification of a polycarboxylic acid or anhydride thereof with polyols and/or an epoxide using techniques known to those skilled in the art. Usually, the polycarboxylic acids and polyols are aliphatic or aromatic dibasic acids and diols. Transesterification of polycarboxylic acid esters using conventional techniques is also possible.

The polyols which usually are employed in making the polyester (or the polyurethane polymer, as described below) include alkylene glycols, such as ethylene glycol and other diols, such as neopentyl glycol, hydrogenated Bisphenol A, cyclohexanediol, butyl ethyl propane diol, trimethyl pentane diol, cyclohexanedimethanol, caprolactonediol, for example, the reaction product of epsilon-caprolactone and ethylene glycol, hydroxy-alkylated bisphenols, polyether glycols, for example, poly(oxytetramethylene) glycol and the like. Polyols of higher functionality may also be used. Examples include trimethylolpropane, trimethylolethane, pentaerythritol, tris-hydroxyethylisocyanurate and the like. Branched polyols, such as trimethylolpropane, are preferred in the preparation of the polyester.

The acid component used to prepare the polyester polymer can include, primarily, monomeric carboxylic acids or anhydrides thereof having 2 to 18 carbon atoms per molecule. Among the acids which are useful are cycloaliphatic acids and anhydrides, such as phthalic acid, isophthalic acid, terephthalic acid, tetrahydrophthalic acid, hexahydrophthalic acid, methylhexahydrophthalic acid, 1,3-cyclohexane dicarboxylic acid and 1,4-cyclohexane dicarboxylic acid. Other suitable acids include adipic acid, azelaic acid, sebacic acid, maleic acid, glutaric acid, decanoic diacid, dodecanoic diacid and other dicarboxylic acids of various types The polyester may include minor amounts of monobasic acids such as benzoic acid, stearic acid, acetic acid and oleic acid. Also, there may be employed higher carboxylic acids, such as trimellitic acid and tricarballylic acid. Where acids are referred to above, it is understood that anhydrides thereof which exist may be used in place of the acid. Also, lower alkyl esters of diacids such as dimethyl glutarate and dimethyl terephthalate can be used. Because it is readily available and low in cost, terephthalic acid is preferred.

Pendent and/or terminal carbamate functional groups may be incorporated into the polyester by first forming a hydroxyalkyl carbamate which can be reacted with the polyacids and polyols used in forming the polyester. The hydroxyalkyl carbamate is condensed with acid functionality on the polyester yielding carbamate functionality. Carbamate functional groups may also be incorporated into the polyester by reacting a hydroxyl functional polyester with a low molecular weight carbamate functional material via a transcarbamoylation process similar to the one described above in connection with the incorporation of carbamate groups into the acrylic polymers or by reacting isocyanic acid with a hydroxyl functional polyester.

The carbamate functional group-containing polyester polymer typically has an Mn of from 500 to 30,000, preferably about 1000 to 5000, and a calculated carbamate equivalent weight within the range of 15 to 150, preferably 20 to 75, based on equivalents of reactive pendent or terminal carbamate groups.

Non-limiting examples of suitable polyurethane polymers having pendent and/or terminal carbamate functional groups include the polymeric reaction products of polyols, which are prepared by reacting the polyester polyols or acrylic polyols, such as those mentioned above, with a polyisocyanate such that the OH/NCO equivalent ratio is greater than 1:1 such that free hydroxyl groups are present in the product. Such reactions employ typical conditions for urethane formation, for example, temperatures of 60° C. to 90° C. and up to ambient pressure, as known to those skilled in the art.

The organic polyisocyanates which can be used to prepare the carbamate functional group-containing polyurethane polymer include aliphatic or aromatic polyisocyanates or a mixture of the two. Diisocyanates are preferred, although higher polyisocyanates can be used in place of or in combination with diisocyanates.

Examples of suitable aromatic diisocyanates include 4,4′-diphenylmethane diisocyanate and toluene diisocyanate. Examples of suitable aliphatic diisocyanates include straight chain aliphatic diisocyanates, such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates include 1,2,4-benzene triisocyanate and polymethylene polyphenyl isocyanate.

Terminal and/or pendent carbamate functional groups can be incorporated into the polyurethane by reacting a polyisocyanate with a polyester polyol containing the terminal/pendent carbamate groups. Alternatively, carbamate functional groups can be incorporated into the polyurethane by reacting a polyisocyanate with a polyester polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer

The carbamate functional group-containing polyurethane polymers typically have an Mn ranging from 500 to 20,000, preferably from 1000 to 5000 and a carbamate equivalent weight within the range of 15 to 150, preferably 20 to 75, based on equivalents of reactive pendent or terminal carbamate groups

Although generally not preferred, for some applications it may be desirable to employ a carbamate functional group-containing polyether polymer in the powder coating compositions of the present invention. Suitable carbamate functional polyether polymers can be prepared by reacting a polyether polyol with urea under reaction conditions well known to those skilled in the art. More preferably, the polyether polymer is prepared by a transcarbamoylation reaction similar to the reaction described above in connection with the incorporation of carbamate groups into the acrylic polymers.

Examples of polyether polyols are polyalkylene ether polyols which include those having the following structural formulae (II) and (III):

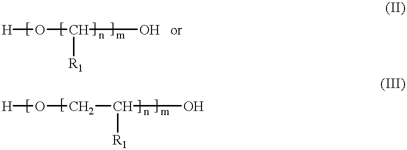

where the substituent R₁ is hydrogen or lower alkyl containing from 1 to 5 carbon atoms including mixed substituents, n is typically from 2 to 6, and m is from 8 to 100 or higher. Note that the hydroxyl groups, as shown in structures (II) and (III) above, are terminal to the molecules. Included are poly(oxytetramethylene) glycols, poly(oxytetraethylene) glycols, poly(oxy-1,2-propylene) glycols and poly(oxy-1,2-butylene) glycols.

Also useful are polyether polyols formed from oxyalkylation of various polyols, for example, diols, such as ethylene glycol, 1,6-hexanediol, Bisphenol A and the like, or other higher polyols, such as trimethylolpropane, pentaerythritol and the like. Polyols of higher functionality which can be utilized as indicated can be made, for instance, by oxyalkylation of compounds, such as sucrose or sorbitol. One commonly utilized oxyalkylation method is reaction of a polyol with an alkylene oxide, for example, propylene or ethylene oxide, in the presence of a conventional acidic or basic catalyst as known to those skilled in the art. Typical oxyalkylation reaction conditions may be employed. Preferred polyethers include those sold under the names TERATHANE and TERACOL, available from E. I. Du Pont de Nemours and Company, Inc. and POLYMEG, available from Q O Chemicals, Inc., a subsidiary of Great Lakes Chemical Corp.

Suitable carbamate functional polyether polymers preferably have a number average molecular weight (Mn) ranging from 500 to 30,000 and more preferably from 1000 to 5000, and a carbamate equivalent weight of within the range of 15 to 150, preferably 25 to 75, based on equivalents of reactive pendent and/or terminal carbamate groups and the solids of the polyether polymer.

As aforementioned, the preferred carbamate functional group-containing polymers also contain residual hydroxyl functional groups which provide additional crosslinking sites Preferably, the carbamate functional group-containing polymer (a) has a hydroxyl value ranging from 10 to 100, more preferably from 10 to 50; and even more preferably from 10 to 20 (mg of KOH per gram).

The carbamate functional group-containing polymer (a) typically is present in the powder coating compositions of the present invention in an amount ranging from at least 5 percent by weight, preferably at least 20 percent by weight, more preferably at least 30 percent by weight, and even more preferably at least 40 percent by weight based on the total weight of resin solids in the film-forming composition. The carbamate functional group-containing polymer (a) also typically is present in the powder coating compositions of the present invention in an amount less than 90 percent by weight, preferably less than 80 percent by weight, more preferably less than 70 percent by weight, and even more preferably less than 60 percent by weight based on the total weight of the powder coating composition. The amount of the carbamate functional group-containing polymer (a) present in the powder coating compositions of the present invention can range between any combination of these values inclusive of the recited values.

The powder coating compositions of the present invention also comprise, as component (b), a curing agent having functional groups reactive with the carbamate functional groups of the polymer (a). The curing agent can be any compound having functional groups reactive with the carbamate (and, if present, hydroxyl) functional groups. In a preferred embodiment, the curing agent (b) is selected from the group consisting of blocked isocyanates, triazine compounds, aminoplast resins, such as glycoluril resins, and mixtures thereof Blocked isocyanates and aminoplast resins, particularly glycoluril resins, are preferred.

The blocked isocyanates suitable for use as the curing agent (b) in the powder coating compositions of the invention are known compounds and can be obtained from commercial sources or may be prepared according to published procedures. Upon being heated to cure the powder coating compositions, the isocyanates are unblocked and the isocyanate groups become available to react with the carbamate functional groups (and hydroxyl functional groups, if present) of the polymer (a).

Any suitable aliphatic, cycloaliphatic or aromatic alkyl monoalcohol known to those skilled in the art can be used as a blocking agent for the isocyanate. Other suitable blocking agents include oximes and lactams. Non-limiting examples of suitable blocked isocyanate curing agents include those based on isophorone diisocyanate blocked with ε-caprolactam; toluene 2,4-toluene diisocyanate blocked with ε-caprolactam; or phenol-blocked hexamethylene diisocyanate. The blocked isocyanates mentioned immediately above are described in detail in U.S. Pat. No. 4,988,793 at column 3, lines 1 to 36. Preferred blocked isocyanate curing agents include BF 1530, which is the reaction product of epsilon-caprolactam blocked T1890, a trimerized isophorone diisocyanate (“IPDI”) with an isocyanate equivalent weight of 280, and BF 1540, a uretidione of IPDI with an isocyanate equivalent weight of 280, all of which are available from Creanova of Somerset N.J.

When employed as the curing agent (b), the blocked isocyanate typically is present in the powder coating compositions of the present invention in an amount ranging from at least 5 percent by weight, preferably at least 20 percent by weight, more preferably at least 30 percent by weight, and even more preferably at least 50 percent by weight based on the total weight of the powder coating composition. The blocked isocyanate also typically is present in the powder coating composition of the present invention in an amount less than 70 weight percent, preferably less than 60 weight percent, more preferably less than 50 weight percent and even more preferably less than 45 weight percent based on the total weight of the powder coating composition. The amount of the blocked isocyanate present in the powder coating compositions of the invention as the curing agent (b) can range between any combination of these values inclusive of the recited values.

Conventional aminoplast crosslinkers can be used provided that the Tg of the coating is not lowered to an undesirable extent. A particularly preferred class of aminoplast resins include aldehyde condensates of glycoluril, which give high melting crystalline products useful in powder coatings. Formaldehyde is the aldehyde most often used to form the condensates, but any of the aldehydes mentioned above can be employed. Glycoluril resins suitable for use as the curing agent (b) in the powder coating compositions of the invention include POWDER LINK 1174 commercially available from Cytec Industries, Inc. of Stamford, Conn.

When employed as the curing agent (b), the aminoplast resin is typically present in the powder coating compositions of the present invention in an amount ranging from at least 5 percent by weight, preferably at least 20 percent by weight, more preferably at least 30 percent by weight, and even more preferably at least 50 percent by weight based on the total weight of resin solids in the film-forming composition. The aminoplast resin also typically is present in an amount less than 70 percent by weight, preferably less than 60 percent by weight, more preferably less than 50 percent by weight, and even more preferably less than 45 percent by weight based on total weight of the powder coating composition. The amount of aminoplast resin present in the powder coating compositions of the invention as the curing agent (b) can range between any combination of these values inclusive of the recited values.

Also known in the art for crosslinking hydroxyl functional group-containing materials are triazine compounds, such as the tricarbamoyl triazine compounds described in detail in U.S. Pat. No. 5,084,541. When used, the triazine curing agent is typically present in the powder coating composition of the present invention in an amount ranging up to about 20 percent by weight, and preferably from about 1 to 20 percent by weight, percent by weight based on the total weight of the powder coating composition.

In a preferred embodiment of the present invention, the curing agent (b) comprises an organosiloxane having at least one of the structural units: (IV):

R¹ₙR²ₘSiO_{(4-n-m)/2} (IV)

wherein each R¹ and R² is independently selected from a monovalent hydrocarbon group, a siloxane group, or OR′, where R′ is H or an alkyl group having 1 to 20 carbon atoms, preferably 1 to 10 carbon atoms; and m and n each represent a positive number fulfilling the requirements of 0<m<4; 0<n<4; and 2≦(m+n)<4. Those skilled in the art recognize that the curing reaction takes place via the group represented by OR′ (i.e., hydroxy or alkoxy groups)

By “monovalent hydrocarbon groups” is meant organic groups containing essentially carbon and hydrogen. The hydrocarbon groups may be aliphatic, aromatic, cyclic or acyclic and may contain from 1 to 24 (in the case of aromatic from 3 to 24) carbon atoms. Optionally, the hydrocarbon groups may be substituted with heteroatoms, typically oxygen. Examples of such monovalent hydrocarbon groups are alkyl, alkoxy, aryl, alkaryl or alkoxyaryl groups. Alkyl groups having 1 to 6 carbon atoms are preferred.

Non-limiting examples of organosiloxanes suitable for use as the curing agent (b) in the powder coating compositions of the present invention include Dow Corning 1-0619, 2-2230 and 1-0619 all available from Dow Corning Corporation.

As aforementioned, the organosiloxane curing agents described above crosslink with the carbamate functional groups of the polymer (a) via the condensation reaction between the CONH₂ groups of the polymer (a) and the HO—Si groups of the organosiloxane to form a —CONH—OSi— linkage. Powder coating compositions which comprise such an organosiloxane as the curing agent (b) provide powder coatings having such improved properties as high temperature resistance, chemical resistance and ultraviolet light resistance.

When employed as the curing agent (b), the organosiloxane is typically present in the powder coating compositions of the present invention in an amount ranging from at least 5 percent by weight, preferably at least 15 percent by weight, more preferably at least 30 percent by weight, and even more preferably at least 45 percent by weight based on the total weight of resin solids in the film-forming composition. The organosiloxane also typically is present in the powder coating compositions of the present invention as the curing agent (b) in an amount less than 90 percent by weight, preferably less than 80 percent by weight, more preferably less than 70 percent by weight, and even more preferably less than 65 percent by weight based on the total weight of the powder coating composition. The amount of organosiloxane present in the powder coating compositions of the invention as the curing agent (b) can range between any combination of these values inclusive of the recited values.

Mixtures of the above-described curing agents also can be used advantageously.

A particularly preferred powder coating composition of the present invention provides a thermally-cured coating having a wrinkled or textured appearance. Such “wrinkle coatings” are commercially desirable for household appliance substrates, for example, substrates used in the assembly of refrigerators, washers, dryers, barbecue grills and the like, where they provide a textured surface resistant to fingerprints, smudging or smearing as a result of grease, dirt or oil.

The powder wrinkle coating composition of the present invention comprises (a) a carbamate functional group-containing polymer, such as those described above, (b) an aminoplast curing agent, preferably a glycoluril resin, such as those described above, and (c) an amine salt of an acid catalyst. Preferably, the curing agent (b) further comprises an organosiloxane of the structure (IV) above, where R¹, R^{2,} m and n are as described above for that structure.

The catalyst (c) can be an amine salt of any inorganic or organic acid, although the amine salts of organic acids are preferred. Non-limiting examples of suitable inorganic acids include phosphonic, and sulfonic adducts thereof. Non-limiting examples of suitable organic acids include substituted sulfonic acids, such as paratoluene sulfonic acid, dodecyl benzene sulfonic acid, dodecyl benzene disulfonic acid, dodecyl naphthyl sulfonic acid, and dodecyl naphthyl disulfonic acid. Examples of amines suitable for forming the acid salts include ethylamine, propylamine, butylamine, benzylamine; ethanolamine, dimethyl ethanolamine, N,N′-diethyl ethanolamine, diisopropanolamine, triethyl amine, and morpholine. Mixtures of amines and the imine versions of the above can also be used. The morpholine salt of para-toluene sulfonic acid is preferred.

The amine salt of an acid catalyst (c) is typically present in the powder wrinkle coating compositions of the present invention in an amount ranging from at least 0.01 percent by weight, preferably at least 0.05 percent by weight, more preferably at least 0.1 percent by weight, and even more preferably at least 0.5 percent by weight based on the total weight of the powder coating composition. The amine salt of an acid catalyst (c) also typically is present in the wrinkle powder coating compositions of the present invention in an amount less than 20 percent by weight, preferably less than 10 percent by weight, more preferably less than 5 percent by weight, and even more preferably less than 2 percent by weight based on the total weight of the powder wrinkle coating composition. The amount of organosiloxane present in the powder coating compositions of the invention as the curing agent (b) can range between any combination of these values inclusive of the recited values.

As aforementioned, upon thermal curing, the powder wrinkle coating composition forms a cured coating which has a textured or wrinkled surface. This wrinkled surface is the result of a difference in cure rate between the surface region and the bulk region of the powder coating.

As used herein, by “surface region” of the applied powder coating is meant the region which is generally parallel to the exposed air-surface of the coated substrate and which has thickness generally extending perpendicularly from the surface of the coating to a depth ranging from 25 to 100 micrometers beneath the exposed surface. As used herein, by “bulk region” of the powder coating is meant the region which extends beneath the surface region and which is generally parallel to the surface of the coated substrate. The bulk region has a thickness extending from its interface with the surface region through the coating to the substrate surface or a coating layer beneath the topcoat.

The amine is believed to serve as a blocking agent to hinder the acid catalysis of the reaction between the carbamate and, if employed, hydroxyl functional groups of the polymer (a) and the functional groups of the aminoplast curing agent (b). Upon exposure to thermal curing conditions, the amine volatilizes, escaping through the exposed air-surface of the coating. The “unblocked” acid groups are then available for catalysis.

During thermal curing of the applied powder wrinkle coating composition, volatilization of the amine used to form the salt of the acid catalyst (c) first occurs in the surface region, thereby allowing catalysis of the crosslinking reaction between the functional groups of the polymer (a) and those of the curing agent (b) to take place at the surface region of the coating. That is, the surface region is at least partially cured prior to curing of the bulk region of the powder coating. As the thermal curing process continues, the amine volatilizes in the bulk region of the coating and migrates to the surface region. As the volatilized amine escapes from the at least partially cured surface region, the coating surface is deformed, thereby providing a “wrinkled” surface.

The powder coating compositions of the present invention can include additives as are commonly known in the art. Typical additives include benzoin, used to reduce entrapped air or volatiles; flow aids or flow control agents which aid in the formation of a smooth and/or glossy surface, for example, MODAFLOW available from Monsanto Chemical Co., waxes such as MICROWAX C available from Hoechst, fillers such as calcium carbonate, barium sulfate and the like; carbon black or Shepard Black pigments and dyes; UV light stabilizers such as TINUVIN 123 or 900 available from Cytec Industries, Inc. and catalysts to promote the various crosslinking reactions.

Examples of catalysts suitable for use in powder coating compositions which comprise a blocked isocyanate as the curing agent (b) include organotin compounds, such as dibutyltin dilaurate, dibutyltin dimaleate, dibutyltin oxide and stannous octanoate. Examples of catalysts suitable for use in powder coating compositions which comprise an aminoplast resin as the curing agent (b) include those acids discussed above with reference to the amine salts of acid catalysts for the powder wrinkle coating compositions.

Such additives are typically present in the powder coating compositions of the present invention in an amount ranging from 5 to 50 weight percent based on total weight of the powder coating composition.

The powder coating compositions of the invention are typically prepared by blending the carbamate functional group-containing polymer (a) and the curing agent (b) for approximately 1 minute in a Henschel blade blender. The powder is then usually catalyzed and extruded through a Baker-Perkins twin screw extruder at a temperature ranging from 70° F. to 130° F. (21.1° C. to 54.4° C.). The finished powder then can be classified to an appropriate particle size, typically between 20 and 200 microns, in a cyclone grinder/sifter.

The powder coating compositions of the invention can be applied to a variety of substrates including metallic substrates, for example, aluminum and steel substrates, and non-metallic substrates, for example, thermoplastic or thermoset composite substrates. The powder coating compositions are typically applied by spraying, and in the case of a metal substrate, by electrostatic spraying which is preferred, or by the use of a fluidized bed. The powder coating can be applied in a single sweep or in several passes to provide a film having a thickness after cure of from about 1 to 10 mils (25 to 250 micrometers), usually about 2 to 4 mils (50 to 100 micrometers).

Generally, after application of the powder coating composition, the powder coated substrate is baked at a temperature sufficient to cure the coating, typically at about 250° F. to 500° F. (121.1° C. to 260.0° C.) for 1 to 60 minutes, and preferably at 300° F. to 400° F. (148.9° C. to 204.4° C.) for 15 to 30 minutes.

The powder coating composition can be applied as a primer or primer surfacer, as a topcoat, for example, a “monocoat”. The powder coating composition of the invention also can be advantageously employed as a substantially unpigmented topcoat, i.e., a clear coat, in a multi-component composite coating composition comprising a pigmented basecoat deposited from a pigmented film-forming composition and a clear coat applied over the base coat, the clear coat being deposited from the powder coating composition as described above.

The film-forming from which the basecoat is deposited can be any of the compositions useful in coatings applications for example, in automotive applications where color-plus-clear systems are most often used. A film-forming composition conventionally comprises a resinous binder and a pigment to serve as a colorant. Particularly useful resinous binders include acrylic polymers, polyesters including alkyds, and polyurethanes.

The resinous binders for the base coat can be organic solvent-based materials, such as those described in U.S. Pat. No. 4,220,679. Water-based coating compositions, such as those described in U.S. Pat. Nos. 4,403,003; 4,147,679; and 5,071,904, also can be used as the base coat composition.

As mentioned above, the base coat compositions also contain pigments of various types as colorants. Suitable metallic pigments include aluminum flake, bronze flake, copper flake and the like. Other examples of suitable pigments include mica, iron oxides, lead oxides, carbon black, titanium dioxide, talc, as well as a variety of color pigments.

Optional ingredients for the base coat film-forming compositions include those which are well known in the art of surface coatings and include surfactants, flow control agents, thixotropic agents, fillers, anti-gassing agents, organic co-solvents, catalysts and other suitable adjuvants.

The base coat film-forming compositions can be applied to the substrate by any of the conventional coating techniques, such as brushing, spraying, dipping or flowing, but they are most often spray-applied The usual spray techniques and equipment for air spraying, airless spraying and electrostatic spraying can be used.

The base coat film-forming compositions are typically applied to the substrate such that a cured base coat having a film thickness ranging from 0.5 to 4 mils (12.5 to 100 micrometers) is formed thereon.

After forming a film of the base coat on the substrate, the base coat can be cured or alternatively given a drying step in which solvent, i.e., organic solvent and/or water, is driven off by heating or an air drying step before application of the clear coat. Suitable drying conditions will depend on the particular base coat film-forming composition and on the ambient humidity with certain water-based compositions. In general, a drying time ranging from 1 to 15 minutes at a temperature of 75° F. to 200° F. (21° C. to 93° C.) is adequate.

The substantially unpigmented powder coating composition is applied to the base coat by any of the methods of application described above. As discussed above, the clear coat can be applied to a cured or a dried base coat before the base coat has been cured. In the latter case, the clear coat and the base coat are cured simultaneously.

Illustrating the invention are the following examples which are not to be considered as limiting the invention to their details. Unless otherwise indicated, all parts and percentages in the following examples, as well as throughout the specification, are by weight.

### EXAMPLES

Example 1 describes the preparation of a carbamate functional group-containing acrylic polymer suitable for use in the powder coating compositions of the present invention. Example A describes the preparation of a powder coating composition of the present invention which contains the carbamate functional acrylic polymer of Example 1 and an organosiloxane curing agent. Comparative Example B describes the preparation of an analogous powder coating composition wherein the carbamate functional polymer has been replaced with a hydroxyl functional group-containing acrylic polymer. Example C describes the preparation of a powder coating composition of the present invention containing the carbamate functional acrylic polymer of Example 1 in conjunction with a glycoluril curing agent. Comparative Example D describes the preparation of an analogous powder coating composition wherein the carbamate functional acrylic polymer has been replaced with a hydroxyl functional acrylic polymer.

### Example 1

This example describes the preparation of a carbamate functional group-containing acrylic polymer for use in the powder coating composition of the present invention. The polymer was prepared from a mixture of the following ingredients:

| INGREDIENT | Weight (grams) |
|---|---|
| SCX-804¹ | 1336.0 |
| Methyl carbamate | 67.6 |
| Butylstannoic acid | 2.53 |
| Triphenyl phosphite | 2.53 |
| Dowanol PM Acetate² | 350.9 |

¹A hydroxyl functional acrylic polymer having a hydroxyl number of 42, commercially available from S.C. Johnson.
²Propylene glycol monomethyl ether acetate, commercially available from Dow Chemical Company.

The above-listed ingredients were charged to a 3 liter 4-necked flask fitted with stirrer, nitrogen inlet, temperature probe and a packed column distillation apparatus fitted with a temperature probe. The mixture was heated to a temperature of 150° C. and held at that temperature for 2 hours under reflux conditions. Collection of the methanol distillate commenced at that time and the nitrogen flow rate was adjusted to keep the distillate temperature <60° C. After a period of 10 hours, the theoretical amount of methanol was removed, and the solvent was then removed in vacuo at 155° C. The final product was 99.8 percent solids (1 hour @ 110°); had a number average molecular weight (Mn) of 6545, and a weight average molecular weight (Mw) of 14,860.

### Examples A-B

Powder coating compositions were prepared as described below in the following Examples A and B. Example A describes the preparation of a powder coating composition of the present invention which includes the carbamate functional group-containing polymer of Example 1. Comparative Example B describes the preparation of the same powder coating composition where the carbamate functional polymer has been replaced with a hydroxyl functional group-containing polymer having no carbamate functionality. The powder coating compositions were prepared from a mixture of the following ingredients:

| | | COMPARATIVE |
|---|---|---|
| | EXAMPLE A | EXAMPLE B |
| INGREDIENTS | (weight in grams) | (weight in grams) |
| MICA C-3000¹ | 840 | 840 |
| Benzoin | 10 | 10 |
| Carbon black pigment | 370 | 370 |
| EPON 2002² | 80 | 80 |
| Organosiloxane³ | 1250 | 1250 |
| Dicyandiamide⁴ | 15 | 15 |
| Zinc acetate | 24 | 24 |
| Carbamate functional | 168 | — |
| polymer of Example 1 | | |
| Hydroxyl functional | — | 168 |
| polymer⁵ | | |

¹A micaceous flake pigment available from R T Vanderbilt.
²A glycidyl ether of Bisphenol A available from Shell Chemical Company.
³DOW CORNING 1-0543, available from Dow Corning Corporation.
⁴Having a functional amine equivalent weight of 18, available from Cytec Industries, Inc.
⁵SCX-804 available from SC Johnson.

POWDER COATING PREPARATION

The powder coating compositions of Examples A and Comparative Example B were prepared as follows. All of the ingredients for each composition were pre-ground in a Henschel grinder for approximately 30 seconds. The pre-ground material was then passed through a Baker-Perkins twin screw extruder at a temperature of 100° C. The resultant “chip” was then ground to an average particle size of 30 microns in a Hosakawa ACM 1 grinder.

PANEL PREPARATION AND TESTING

The powder coating compositions were spray applied using a Nordson Versa Spray II corona powder charging system with gun settings at 80-100 Kv and fluidizing air setting at 1-2 psi. The compositions were applied to Bonderite 1000 cold rolled steel test panels (available from ACT Laboratories, Inc. of Hillsdale, Mich.) at a cured film thickness of 1 to 4 mils (25 to 100 micrometers). Coated test panels were thermally cured at a temperature of 350° F. (177° C.) for 30 minutes.

The powder coating compositions were evaluated for powder stability (7days at 40° C.)) and “gel times”. Gel times were determined using a thermo-electric cure plate at a temperature of 170C. The observed gel time is registered visually and the time noted occurs when the molten material does not reflow when disturbed in the melt state.

The coated test panels were evaluated for adhesion, chemical resistance and UV resistance properties. Crosshatch adhesion was evaluated in accordance with ASTM D-3359-83. UV resistance is registered as loss of gloss upon exposure to 313 nm radiation in a QUV cabinet available from the Q-Panel Company of Cleveland, Ohio

Test results are reported in the following Table 1.

TABLE 1

| | | COMPARATIVE |
|---|---|---|
| PROPERTY TESTED | EXAMPLE A | EXAMPLE B |
| Gel Time @ 170° C. | 2 hours | 2 hours |
| Powder stability | Excellent | Poor (powder sintered) |
| Adhesion | 4B | 5B |
| Chemical resistance | Excellent | Poor |
| UV resistance | Excellent | 30% gloss reduction |
| (1000 hours/313 nm) | | |

The data presented in Table 1 above illustrate that the powder coating composition of the present invention (Example A) which contains the carbamate functional polymer of Example 1 in conjunction with the organosiloxane curing agent, provides powder stability, chemical resistance and UV resistance superior to those properties provided by the analogous composition which contains a hydroxyl functional polymer (Comparative Example B).

### Examples C-D

The following Examples C and D describe the preparation of powder coating compositions based on a glycoluril curing agent. Example C describes the preparation of a powder coating composition of the present invention containing the carbamate functional group-containing polymer of Example 1 as well as a hydroxyl functional group-containing polymer Comparative Example D describes the preparation of an analogous powder coating composition wherein the carbamate functional polymer is replaced with a hydroxyl functional group-containing polymer. The powder compositions were prepared from a mixture of the following ingredients:

| | | COMPARATIVE |
|---|---|---|
| | EXAMPLE C | EXAMPLE D |
| INGREDIENTS | (weight in grams) | (weight in grams) |
| POWDERLINK MTSI¹ | 4 | 4 |
| POWDERLINK 1174² | 30 | 30 |
| MODAFLOW³ | 3 | 3 |
| CRYLCOAT 690⁴ | 160 | 420 |
| Carbon black pigment | 15 | 15 |
| Barium sulfate | 260 | 260 |
| EPON 2002 | 30 | 30 |
| Carbamate functional | 300 | — |
| polymer of Example 1 | | |

¹Potassium salt of p-toluenesulfonamide available from Cytec Industries, Inc.
²Crystalline glycoluril resin commercially available from Cytec Industries, Inc.
³A polyacrylate flow additive commercially available from Monsanto Chemical Co.
⁴Ultradurable hydroxyl functional acrylic polymer having a hydroxyl number of 40, available from UCB Chemicals.

The powder coating compositions of Examples C and D were prepared and applied as described above with reference to the powder coating compositions of Examples A and B. The coated test panels were evaluated for hardness (as determined by pencil hardness in accordance with ASTM- D-3363-74); crosslink density or extent of curing (as determined by double rubs with methyl ethyl ketone (“MEK”)); UV resistance (as described above) and adhesion (as determined by crosshatch adhesion testing in accordance with ASTM D-3359-83). Test results are reported in the following Table 2.

TABLE 2

| | | COMPARATIVE |
|---|---|---|
| PROPERTY TESTED | EXAMPLE C | EXAMPLE D |
| Pencil hardness | 3H | H |
| Methyl ethyl ketone | No mar; no softening | Mar; film soft |
| 200 double rubs | | |
| UV resistance | Slight fade; no loss of gloss | 90% loss of gloss |
| (500 hours) | | |
| Adhesion | Excellent | Excellent |

The data presented in Table 2 above illustrate that the powder coating composition of the present invention (Example C) containing the carbamate functional acrylic polymer in conjunction with the glycoluril curing agent provide coatings with hardness, UV resistance and adhesion properties superior to an analogous powder coating composition wherein the carbamate functional polymer is replaced with the hydroxyl functional acrylic polymer (Comparative Example D). The MEK double rub data also illustrate that the powder coating composition of Example C provides a coating having increased crosslink density as compared to that provided by the comparative powder coating composition of Example D.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

Therefore we claim:

1. A powder coating composition comprising a solid particulate film-forming mixture of the following components:
(a) a polymer comprising pendent and/or terminal carbamate functional groups, said polymer having a glass transition temperature at least 30° C.; and
(b) a curing agent having functional groups reactive with the carbamate functional groups of the polymer (a).

2. The powder coating composition of claim 1, wherein said polymer is selected from the group consisting of acrylic, polyurethane, polyether, and polyester polymers and mixtures thereof.

3. The powder coating composition of claim 2, wherein said polymer is an acrylic polymer.

4. The powder coating composition of claim 2, wherein said polymer is a polyester polymer.

5. The powder coating composition of claim 2, wherein said polymer is a polyurethane polymer.

6. The powder coating composition of claim 1, wherein said polymer (a) has a glass transition temperature ranging from 30° C. to 110° C.

7. The powder coating composition of claim 1, wherein the polymer (a) is present in an amount ranging from 5 to 90 weight percent based on total weight of the composition.

8. The powder coating composition of claim 1, wherein said curing agent (b) is selected from the group consisting of blocked isocyanates, triazine compounds, aminoplast resins and mixtures thereof.

9. The powder coating composition of claim 8, wherein said curing agent (b) is a blocked isocyanate.

10. The powder coating composition of claim 8, wherein said aminoplast resin is a glycoluril resin.

11. The powder coating composition of claim 1, wherein said curing agent (b) comprises an organosiloxane having at least one of the following structural units (I):
R¹ₙR²ₘSiO_{(4-n-m)/2} (I)
wherein each R¹ is independently selected from a monovalent hydrocarbon group or a siloxane group; each R² is independently OR′, where R′ is H or an alkyl group having 1 to 20 carbon atoms; and m and n each represent a positive number fulfilling the requirements of 0<m<4; 0<n<4; and 2≦(m+n)<4.

12. The powder coating composition of claim 11, wherein at least one R² is OH.

13. The powder coating composition of claim 1, wherein the curing agent (b) is present in an amount ranging from 5 to70 weight percent based on total weight of the composition.

14. The powder coating composition of claim 11, wherein the curing agent (b) is present in an amount ranging from 5 to 90 weight percent based on total weight of the composition.

15. The powder coating composition of claim 1, further comprising one or more pigments.

16. The powder coating composition of claim 1, further comprising (c) an amine salt of an acid.

17. The powder coating composition of claim 16, wherein (c) is an amine salt of a sulfonic acid.

18. The powder coating composition of claim 17, wherein (c) is the morpholine salt of para-toluene sulfonic acid.

19. A multi-component composite coating composition comprising a pigmented basecoat deposited from a pigmented film-forming composition and a top coat applied over the basecoat, said top coat deposited from a powder coating composition comprising a solid particulate film-forming mixture of the following components:
(a) a polymer comprising pendent and/or terminal carbamate functional groups, said polymer having a glass transition temperature of at least 30° C; and
(b) a curing agent having functional groups reactive with the carbamate functional groups of the polymer (a).

20. The multi-component composite coating composition of claim 19, wherein said polymer is selected from the group consisting of acrylic, polyurethane, polyether, and polyester polymers and mixtures thereof.

21. The multi-component composite coating composition of claim 20, wherein said polymer is an acrylic polymer.

22. The multi-component composite coating composition of claim 20, wherein said polymer is a polyester polymer.

23. The multi-component composite coating composition of claim 20, wherein said polymer is a polyurethane polymer.

24. The multi-component composite coating composition of claim 19, wherein the polymer (a) has a glass transition temperature ranging from 30° C. to 110° C.

25. The multi-component composite coating composition of claim 19, wherein the polymer (a) is present in an amount ranging from 5 to 90 weight percent based on total weight of the powder coating composition.

26. The multi-component composite coating composition of claim 19, wherein the curing agent (b) is selected from the group consisting of blocked isocyanates, triazine compounds, aminoplast resins and mixtures thereof.

27. The multi-component composite coating composition of claim 26, wherein the curing agent (b) is a blocked isocyanate.

28. The multi-component composite coating composition of claim 26, wherein the aminoplast resin is a glycoluril resin.

29. The multi-component composite coating composition of claim 19, wherein the curing agent (b) comprises an organosiloxane having at least one of the following structural units (I):
R¹ₙR²ₘSiO_{(4-n-m)/2} (I)
wherein each R¹ is independently selected from H, a monovalent hydrocarbon group or a siloxane group; each R² is independently OR′, where R′ is H or an alkyl group having 1 to 20 carbon atoms; and m and n each represent a positive number fulfilling the requirements of 0<m<4; 0<n<4; and 2≦(m+n)<4.

30. The multi-component composite coating composition of claim 29, wherein at least one R² is OH.

31. The multi-component composite coating composition of claim 19, wherein the curing agent (b) is present in an amount ranging from 5 to 70 weight percent based on total weight of the powder coating composition.

32. The multi-component composite coating composition of claim 29, wherein the curing agent (b) is present in an amount ranging from 5 to 90 weight percent based on total weight of the powder coating composition.

33. The multi-component composite coating composition of claim 19, further comprising one or more pigments.

34. The multi-component composite coating composition of claim 19, further comprising (c) an amine salt of an acid.

35. The multi-component composite coating composition of claim 34, wherein (c) is an amine salt of a sulfonic acid.

36. The multi-component composite coating composition of claim 34, wherein (c) is the morpholine salt of para-toluene sulfonic acid.

37. A method of forming a wrinkled coating on a substrate comprising the following steps:
(1) preparing a thermosetting powder coating composition by forming a solid particulate film-forming mixture of the following components:
(a) a polymer comprising pendent and/or terminal carbamate functional groups, said polymer having a glass transition temperature of at least 30° C.;
(b) a curing agent having functional groups reactive with the carbamate functional groups of the polymer (a); and
(c) a catalyst comprising an amine salt of a sulfonic acid;
(2) applying the powder coating composition of step (1) to a substrate; and
(3) thermally curing the powder coated substrate to form a continuous, wrinkled film thereon.

38. The method of claim 37, wherein the curing agent (b) further comprises an organosiloxane having at least one of the following structural units (I):
R¹ₙR²ₘSiO_{(4-n-m)/2} (I)
wherein each R¹ is independently selected from a monovalent hydrocarbon group or a siloxane group; each R² is independently OR′, where R′ is H or an alkyl group having 1 to 20 carbon atoms; and m and n each represent a positive number fulfilling the requirements of 0<m<4; 0<n<4; and 2≦(m+n)<4.

39. The method of claim 37, wherein the curable powder coating composition comprises a solid particulate film-forming mixture of the following components:
(a) 5 to 90 weight percent based on total weight of the composition of an acrylic polymer comprising pendent and/or terminal carbamate functional groups, said acrylic polymer having a glass transition temperature of at least 30° C.;
(b) 5 to 70 weight percent based on total weight of the composition of a glycoluril resin; and
(c) 0.01 to 2.0 weight percent based on total weight of the composition of a morpholine salt of para-toluene sulfonic acid.

40. The method of claim 39, wherein the curing agent (b) further comprises 5 to 90 weight percent based on total weight of the composition of an organosiloxane having at least one of the following structural units (I):
R¹ₙR²ₘSiO_{(4-n-m)/2} (I)
wherein each R¹ is independently selected from a monovalent hydrocarbon group or a siloxane group; each R² is independently OR′, where R′ is H or an alkyl group having 1 to 20 carbon atoms; and m and n each represent a positive number fulfilling the requirements of 0<m<4; 0<n<4; and 2≦(m+n)<4.

41. A substrate coated with the powder coating composition of claim 1.

42. A substrate coated with the powder coating composition of claim 11.

43. A substrate coated with the multi-component composite coating composition of claim 19.

44. A substrate coated with the multi-component composite coating composition of claim 29.

45. A substrate coated by the method of claim 37.
